(19) United States
(12) Patent Application Publication
(10) Pub. No.: US 2006/0153514 A1
(43) Pub. Date: Jul. 13, 2006

(54) Device for thermally treating at least one optical fibre

(76) Inventor: Karsten Contag, Munich (DE)

Correspondence Address: Thomas M Fisher;Corning Cable Systems, Post Office Box 489, Hickory, NC, 28603, US

(21) Appl. No.: 10/533,282

(22) PCT Filed: Oct. 31, 2003
(86) PCT No.: PCT/DE03/03630

§ 371 Date: Apr. 28, 2005

(30) Foreign Application Priority Data
Oct. 31, 2002 (DE) 102 50 880.1

(51) Int. Cl. G02B 6/00

(52) U.S. Cl. 385/134

(57) ABSTRACT

A device for thermally treating at least one optical waveguide has a radiation source. A first optical system is used to direct a beam, emitted by the radiation source, onto the optical waveguide from a first side. The first optical system generates a beam profile whose extent in the transverse direction with respect to a longitudinal axis of the optical waveguide corresponds to at least twice an optical waveguide diameter. The optical waveguide is positioned completely outside a center axis of the beam profile in the transverse direction with respect to the longitudinal axis of the optical waveguide in the focusing area of the beam. A second optical system which is positioned behind the optical waveguide in the direction of a beam path of the beam, reflects and directs a beam, which is transmitted past the side of the optical waveguide, onto the optical waveguide from a second side.

This National stage application claims the benefit of International Application No. PCT/DE03/03630, filed on Oct. 31, 2003, which claims the benefit of German Patent Application No. 10250880.1, filed on Oct. 31, 2002, and which was not published in the English language under PCT Article 21(2).

### FIELD OF THE INVENTION

The present invention relates to a device for thermally treating at least one optical waveguide having a radiation source and having an optical system for directing a beam, emitted by the radiation source, onto the optical waveguide.

### BACKGROUND OF THE INVENTION

In a method for thermally splicing optical waveguides, glass fibers which are to be connected are generally heated to melting temperature by a heat source and placed in contact. Contemporary splicing devices generally use an electric glow discharge as an energy source for the splicing process. It is also possible to use a laser, preferably a CO₂ laser, as a heat source, said laser providing the advantage of being able to influence the shape of the heating zone by shaping the beam profile at the location of the splice and/or by controlling the power density profile by moving the laser beam over the splice, as described, for example, in the German patent application 102 127 16.6 which was not published before the application date of the present application. During the splicing process, the optical waveguides to be spliced are located in a zone of influence of the laser radiation and are thus heated to melting temperature. Both the intensity of the heating of the optical waveguides and the size of the heating zone are significant, in addition to other parameters, for the quality of the spliced connection which is obtained.

A problem when using a laser beam as the heat source is that when the laser beam strikes the optical waveguide on one side, a temperature gradient is produced between the side facing the laser beam and the side of the optical waveguides facing away from the laser beam.

This may result in an asymmetry of the splice which can lead to incomplete welding of the two ends of the optical waveguides. The splice quality, characterized in particular by the coupling losses which occur and the tensile strength of the splice, is generally worsened when heat is applied on one side.

The problem could be solved by setting the power density at the location of the splice in conjunction with the times control of the laser power in such a way that the temperature gradient is reduced over the cross section of the fiber. In particular this can be achieved by reducing the power density in conjunction with an increase in the splicing time. The disadvantage of this solution is that when the splicing time is increased the heating zone is also made larger. This contradicts the idea of selectively influencing the shape of the heating zone by using a laser beam instead of a conventional glow discharge.

U.S. Pat. No. 4,263,495 describes a method in which a laser is used as an energy source for splicing optical waveguides. In this method, the laser beam is focused in order to obtain a sufficient power density. The radiation of the laser is bundled by lenses or combinations of lenses and mirrors in such a way that a focusing area in which the radiation strikes the optical waveguides is produced with an increased power density. The glass fibers to be spliced are arranged in this focusing area so that the desired heating of the optical waveguides is achieved.

In this document, it is proposed in particular to use a focusing mirror along whose axis of symmetry the fibers to be spliced are positioned. By using a collimated laser beam which strikes the mirror parallel to the axis of symmetry and whose power is distributed symmetrically around the axis of symmetry, the optical waveguide or the splice is heated at the focal point of the mirror from all sides. The disadvantage with this solution is that when the mirror has a large focal length the mounts of the two fibers are located in the optical beam path and they in turn give rise to shading and thus to unequal heating. If the mirror has a short focal length the mirror is located so close to the splice that material which is evaporated during the splicing process is deposited on the mirror and the mirror therefore has to be cleaned or replaced frequently.

The present invention is based on the object of specifying a device for thermally treating at least one optical waveguide which permits one or more waveguides to be heated uniformly without the abovementioned disadvantages.

This object is achieved by means of a device according to patent claim 1.

According to the invention, a beam profile of the emitted beam is generated by means of a first optical system, with the extent of the beam profile in the transverse direction with respect to a longitudinal axis of the optical waveguide or waveguides corresponding to at least twice a diameter of an optical waveguide. The optical waveguide or guides are positioned completely outside a center axis of the beam profile in the transverse direction with respect to a longitudinal axis of one of the optical waveguides in the focusing area of the beam inside which the radiation strikes the optical waveguide or guides. A second optical system, which is positioned behind the optical waveguide or guides in the direction of the beam path of the beam is used to reflect the radiation which is transmitted past the side of the optical waveguide or guides and to direct it onto the optical waveguide or guides from a second side. In this way, the radiation is made to strike the optical waveguide or guides from two sides, preferably two opposite directions, and heat it/them. In the process, the power density profile which extends from one side is preferably approximately the same as the power density profile which affects the optical waveguide or guides from the other side.

The device according to the invention can preferably be used for splicing a plurality of optical waveguides, in particular for splicing two optical waveguides as explained in more detail in the introduction. However, the device is also generally suitable for thermally treating one or more optical waveguides, in particular for thermally expanding a fiber core or for enlarging or reducing the size of the fiber diameter (referred to as “tapering”) of an optical waveguide.

The invention advantageously makes it possible to provide a simple optical system which directs the radiation onto the optical waveguide or guides with a suitable form and position of the beam profile at the position of the optical waveguide or guides, from two directions, preferably opposite directions, with an approximately equal power density. At the same time, the device can be arranged in such a way that the optical waveguide or guides are affected at the same position along the longitudinal axis from both directions. The configuration is in particular such here that this is the case even if the point where the radiation strikes the optical waveguide or waveguides is moved along the longitudinal axis or axes of said waveguide or guides.

The second optical system is configured in particular in such a way that it images the beam profile emitted by the radiation source in a plane parallel to an optical waveguide longitudinal axis in a different way than in a plane extending transversely with respect to the optical waveguide longitudinal axis. In particular, the second optical system is embodied in such a way that it images the beam profile in a noninverted fashion in the plane parallel to the optical waveguide longitudinal axis and images it in an inverted fashion in the plane extending transversely with respect to the optical waveguide longitudinal axis, in particular in each case with an approximate ratio of 1:1 here.

Further advantageous embodiments and developments of the invention are specified in subclaims.

The invention is explained in more detail below with reference to the figures which are illustrated in the drawing and represent preferred exemplary embodiments of the present invention.

### BRIEF DESCRIPTION OF THE DRAWINGS

The advantages and preferred embodiments and developments of the invention are described below by means of a preferred embodiment of the device for splicing a plurality of optical waveguides. However, the same applies analogously to a device for thermally treating just one optical waveguide. In the drawing:

FIG. 1 shows a schematic illustration of an embodiment of a device according to the invention for focusing laser radiation emitted by a laser onto optical waveguides to be spliced,

FIG. 2 shows a schematic illustration of the beam profile at the location of the optical waveguides when it is first incident, after transmission and after reflection onto the optical waveguides,

FIG. 3 shows a schematic illustration of a first embodiment of the invention relating to the second optical system for reflecting the laser radiation onto the optical waveguides,

FIG. 4 shows a schematic illustration of a second embodiment of the invention relating to the second optical system for reflecting the laser radiation onto the optical waveguides,

FIG. 5 shows a schematic illustration of a third embodiment of the invention relating to the second optical system for reflecting the laser radiation onto the optical waveguides,

FIG. 6 shows a schematic illustration of a fourth embodiment of the invention relating to the second optical system for reflecting the laser radiation onto the optical waveguides,

FIG. 7 shows a schematic illustration of a plurality of exemplary embodiments for splicing a plurality of optical waveguides lying one next to the other, and

FIG. 8 is a basic outline relating to a further embodiment of the invention.

### DETAILED DESCRIPTION OF THE INVENTION

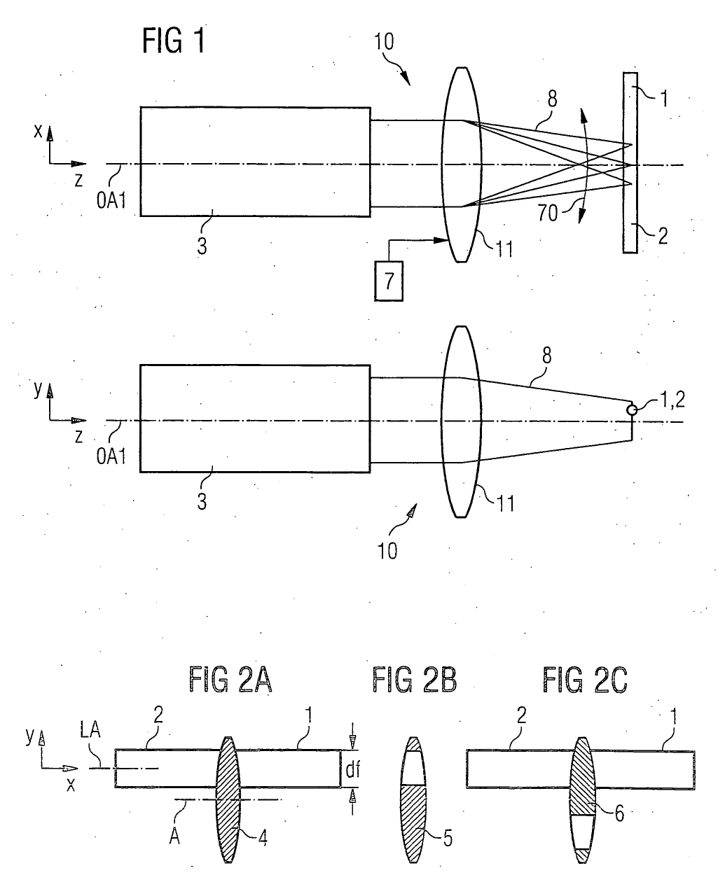

FIG. 1 shows a schematic illustration of an embodiment of the device according to the invention. A laser beam source 3 and a first optical system 10 for directing and preferably focusing a laser beam 8 emitted by the laser beam source onto the optical waveguide fibers 1 and 2 are represented. The first optical system 10 also includes the radiation optics of the laser for directing the laser beam.

FIG. 1 shows by way of example the imaging of the laser beam 8 onto the fibers to be spliced from two orthogonal directions. In the direction along the longitudinal axes of the fibers 1, 2, the laser beam 8 can be shifted in the longitudinal direction thereof, in particular moved periodically (movement direction 70 of the laser radiation 8). This uses a schematically illustrated drive device 7, which moves an optical component in the form of a lens 11 in such a way that a position of a focusing area of the laser beam inside which the radiation strikes the optical waveguide fibers is shifted periodically in the longitudinal direction thereof. In this respect, only a simple embodiment is shown in FIG. 1, but it will also be conceivable to deflect the laser beam 8 by means of an optical component in the form of a corresponding mirror and to move such a mirror periodically by means of a corresponding drive device. Such a mirror may be located in front of or behind the lens in the beam path.

The lens 11 and the optical system 10 which is used for imaging is configured in such a way that the extent of the beam profile of the laser beam 8 in the transverse direction with respect to the longitudinal axis of the fibers is at least twice as large at the location of the fibers 1, 2 as the maximum diameter of the fibers.

Furthermore, a coordinate system composed of X axis, Y axis and Z axis is illustrated in FIG. 1. The X axis extends parallel to the longitudinal axis of the fibers and the Z axis perpendicular thereto. In turn, the Y axis extends in a third dimension perpendicularly with respect to the X axis and Z axis. The optical axis of the optical system 10 is designated by OA1.

FIG. 2 shows a schematic illustration of the beam profile of the laser beam 8 at the location of the optical waveguides when the beam is first incident (FIG. 2a), after transmission (FIG. 2b) and after reflection onto the optical waveguides (FIG. 2c). As is apparent from FIG. 2a, the fibers 1, 2 are located completely outside the center axis A of the preferably symmetrical beam profile 4 of the laser beam in the transverse action with respect to the longitudinal axis LA of the fibers. The fibers 1, 2 have a fiber diameter df. The fibers 1, 2 are located above or below the center axis A of the beam profile 4. FIG. 2b illustrates the beam profile 5 which is transmitted through the fibers or past the side of the fibers, with part of the laser radiation having been absorbed by the fibers (light part of the illustrated beam profile 5). A second suitable optical system is used to image the laser radiation a second time on the fibers 1, 2 and said beam strikes the fibers from the opposite direction. The resulting beam profile 6 at the location of the fibers is illustrated in FIG. 2c. In this case the radiation which was transmitted past the side of the fibers according to the first illustration strikes the fibers 1, 2 according to the second illustration.

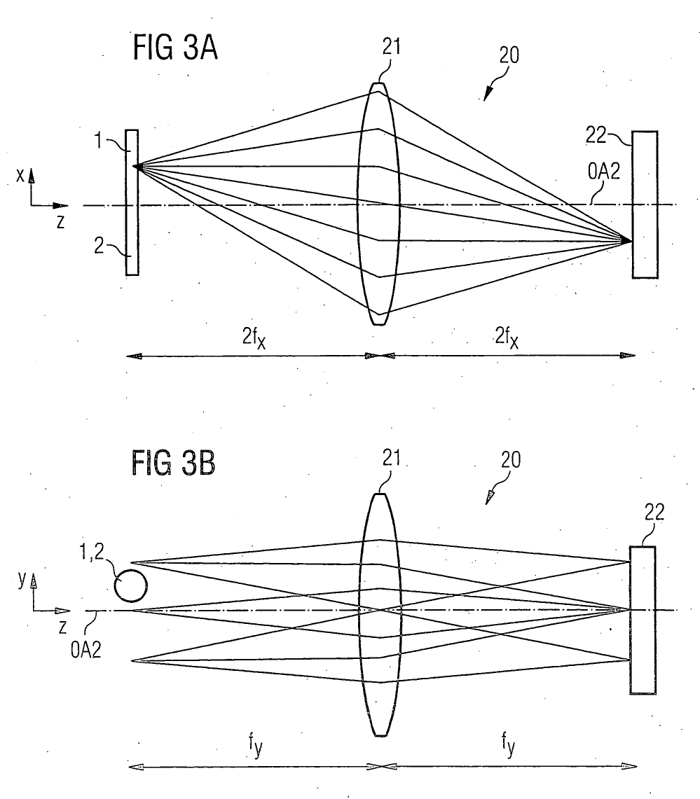

FIG. 3 shows a schematic illustration of a first exemplary embodiment of the invention relating to the second optical system for reflecting the laser radiation onto the optical waveguide fibers. The second optical system 20 for reflecting the laser radiation has a plane mirror 22 and an aspherical lens 21, with the lens 21 being arranged between the fibers 1, 2 and the plane mirror 22. The aspherical lens 21 has two different focal lengths fx and fy in the XZ plane parallel to the longitudinal axes of the fibers or in the YZ plane extending transversely with respect to the longitudinal axes of the fibers. In the present exemplary embodiment, in the XZ plane parallel to the longitudinal axes of the fibers the distance between the lens 21 and the fibers 1, 2 is equal to the distance between the lens 21 and the mirror 22. The focal length fx of the lens 21 in this plane is half this distance. As a result, in this plane a noninverted imaging of the beam profile on the fibers is brought about approximately to the scale 1:1. According to the second illustration, as a result of the second optical system 20 the radiation strikes the fibers 1, 2 at the same position in this plane as in the first illustration by means of the first optical system 10 according to FIG. 1, even when the laser beam is deflected along the longitudinal axes of the fibers as illustrated in FIG. 3a.

In the YZ plane extending transversely with respect to the longitudinal axes of the fibers, the focal length fy of the aspherical lens 21 is essentially equal to the distance between the lens and the fibers (FIG. 3b). As a result, in this plane inverted imaging of the beam profile onto the fibers is brought about approximately with a scale of 1:1. This results in the laser radiation which was transported past the side of the fibers in the first illustration according to FIG. 1, striking the fibers as a result of the optical system 20 according to the second illustration.

With respect to the abovementioned distances in the exemplary embodiment according to FIG. 3 and the distances in the exemplary embodiments explained below it is to be noted that these distances are not compulsory. Instead, by suitably configuring the optical system it is possible to reduce the emitted laser radiation at the reflecting mirror, with the reduced image during the reflecting onto the fibers being correspondingly enlarged again. The distances between the optical components are to be set correspondingly. Furthermore, it is to be noted that the aforesaid distances between the optical elements and the fibers constitute only approximate values which may change when the optical imaging is configured more precisely. In this context, in particular the thicknesses of the lenses are significant. According to previous knowledge it is to be assumed that the distances may change in the region from about 10% owing to the aforementioned precise configuration.

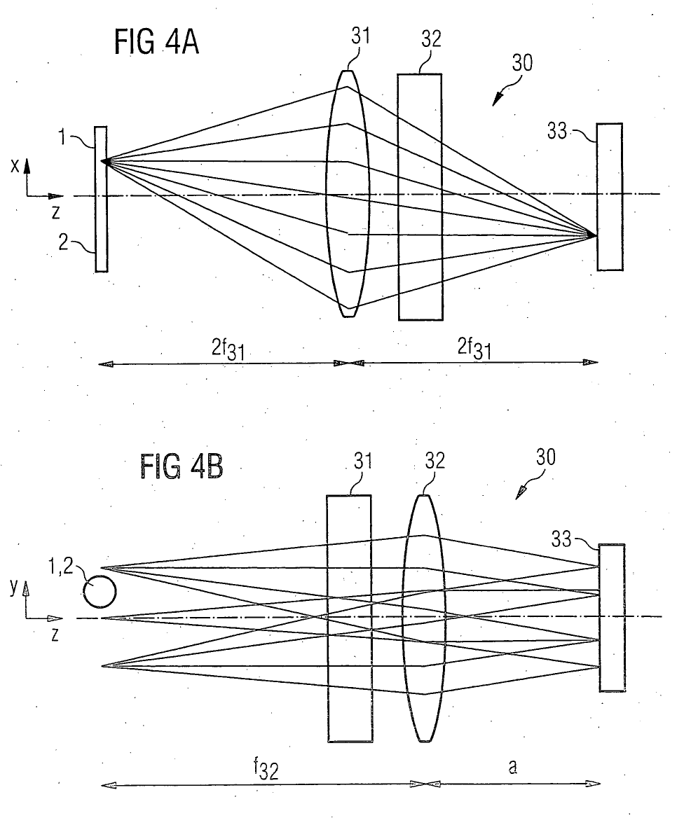

FIG. 4 shows a further schematic illustration of a second inventive embodiment of the second optical system for reflecting the laser radiation onto the optical waveguide fibers. This particularly favorable exemplary embodiment of the second optical system 30 contains a plane mirror 33 and two cylindrical lenses 31 and 32 as optical elements. In the present exemplary embodiment, the distance between the lens 31 and the fibers 1, 2 is equal to the distance between the lens 31 and the mirror 33. The focal length f31 of the lens 31 in the XZ plane parallel to the fiber axes corresponds to half this distance. The second lens 32 does not have any refractive power in the XZ plane. In this plane, noninverted imaging of the beam profile is thus carried out on the fibers with an approximate scale of 1:1.

In the YZ plane extending transversely with respect to the fiber axes, the second lens 32 has a focal length f32 which corresponds to its distance from the fibers 1, 2. The distance a between the lens 32 and the mirror 33 can be selected here as desired within practical limits. It is also possible to position the lens 32 in front of the lens 31 (a>2f31 and f32<2f31). The lens 31 does not have any refractive power in the YZ plane. In this plane inverted imaging on the fibers with an approximate scale of 1:1 is thus achieved.

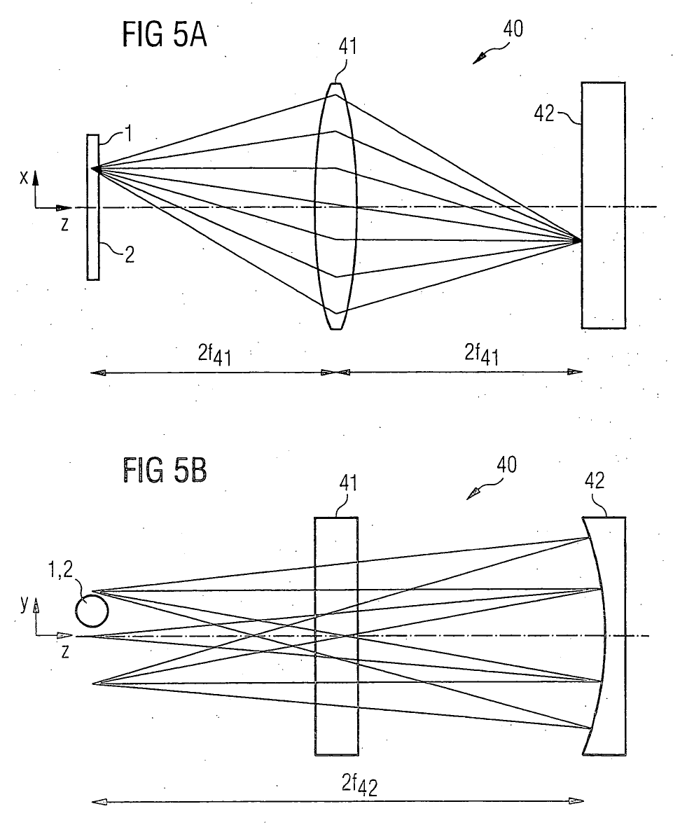

FIG. 5 is a schematic illustration of a third inventive exemplary embodiment of the second optical system for reflecting the laser radiation onto the optical waveguide fibers. This exemplary embodiment of the second optical system 40 which is also particularly favorable has a cylindrical lens 41 and a cylindrical mirror 42 which is concave in the YZ plane. In the present exemplary embodiment, the distance between the cylindrical lens 41 and the fibers 1, 2 is equal to the distance between the lens 41 and the mirror 42. The focal length f41 of the lens 41 in the XZ plane parallel to the longitudinal axes of fibers corresponds to half this distance. The mirror 42 does not have any focusing effect in this plane, that is to say it is made planar in the XZ plane. In this plane, non-inverted imaging of the beam profile on the fibers with an approximate scale of 1:1 is thus achieved.

In the YZ plane extending transversely with respect to the longitudinal axes of the fibers the mirror 42 has a focal length f42 which corresponds, in the present exemplary embodiment, to half the distance between the mirror 42 and the fibers 1, 2 (FIG. 5b). The cylindrical lens 41 does not have any refractive power in the YZ plane. In this plane, inverted imaging by the optical system 40 onto the fibers with an approximate scale of 1:1 is thus achieved.

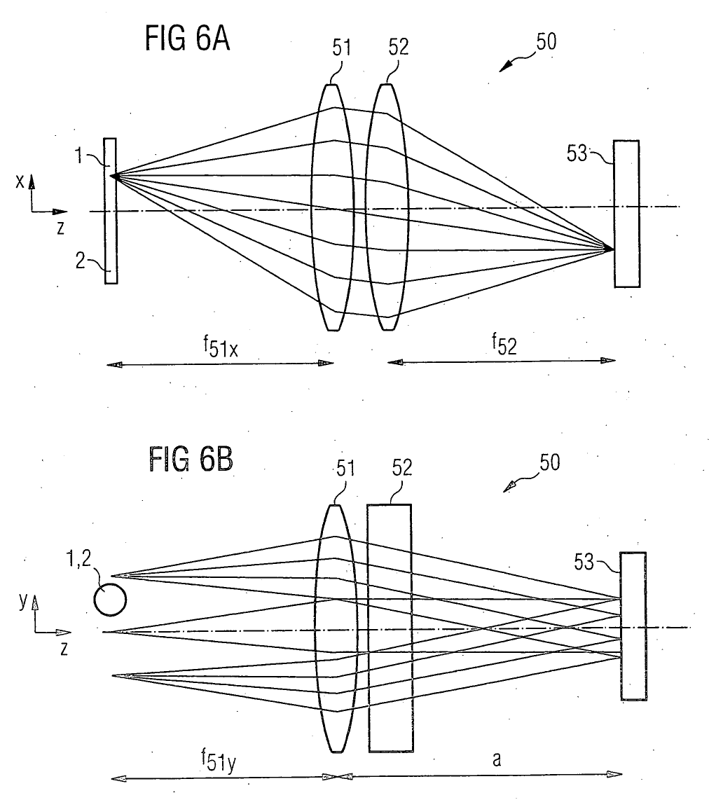

FIG. 6 shows a further schematic illustration of a fourth inventive exemplary embodiment of the second optical system for reflecting the laser radiation onto the optical waveguide fibers. This exemplary embodiment of the second optical system 50 contains a plane mirror 53, a cylindrical lens 52 and a spherical lens 51 as optical elements. The spherical lens 51 has identical refractive power f51x and f51y in both planes xz and yz. The cylindrical lens 52 preferably does not have any refractive power in the yz plane. In this example, the focal length of the spherical lens 51 is essentially equal to the distance between this lens and the optical waveguides. The distance a between the lens 51 and the mirror 53 can be selected as desired here within practical limits.

It would also be conceivable to use a defocusing cylindrical lens in combination with a focusing spherical lens. In this case, the spherical lens would not have any refractive power in the xz plane. In the yz plane there would then be a resulting focal length from both lenses. The distance between an element which acts equivalently to the sum of the two lenses and the optical waveguides would be equal to this resulting focal length.

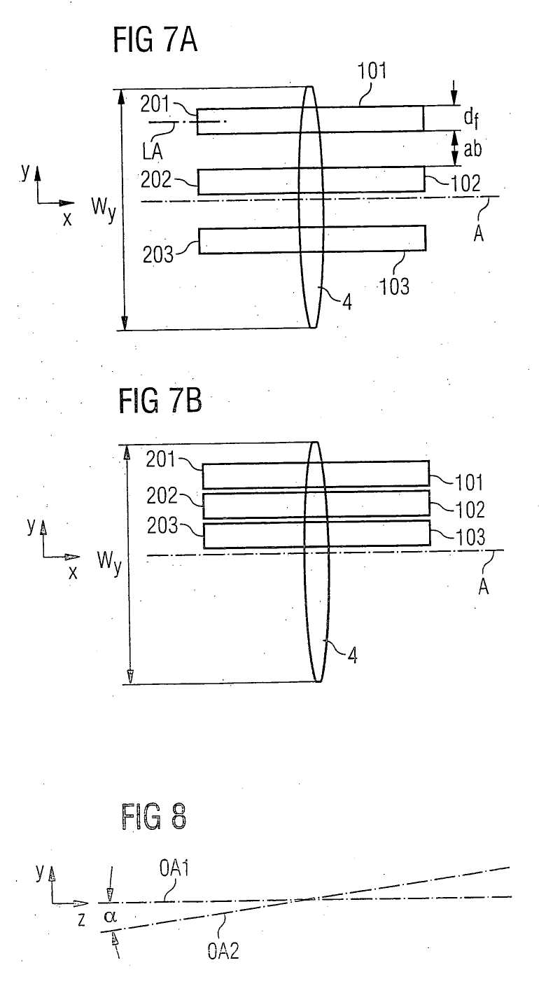

FIG. 7 is a schematic illustration of a plurality of inventive exemplary embodiments of the welding of a plurality of optical waveguide fibers lying one next to the other. The device according to the invention is configured here in such a way that a plurality of optical waveguides 101 to 103 which are arranged one next to the other and which form, for example, a fiber cable can be welded in parallel with optical waveguide fibers 201 to 203 lying correspondingly opposite. As a result, all the fibers of two optical waveguide fiber cables can be welded to one another simultaneously. For this purpose, an optical arrangement can, as described above with reference to the explained exemplary embodiments, be used in principle without modification. Only the beam profile of the first optical imaging of the laser radiation at the location of the optical waveguide fibers is to be correspondingly configured. Two possible exemplary embodiments for this purpose are illustrated by way of example for three fiber pairs in FIG. 7.

In FIG. 7a, the distance ab between two fibers 101 and 102 lying one next to the other corresponds to at least the largest diameter df of the fibers. The extent Wy of the beam profile extending transversely with respect to the axes of the fibers corresponds to at least the sum of the diameters df of all the optical waveguides 101 to 103 and 201 to 203 lying one next to the other and of the intermediate distances ab. A corresponding distance is also assigned to the outermost fiber 103 or 203, that is to say the beam profile 4 extends over the outermost optical waveguide 103, 203 by a length of the order of magnitude of at least one diameter df of a fiber. The fibers are arranged in such a way that when there is reflection about the horizontal center axis A of the beam profile 4 each reflected fiber comes to rest in an intermediate space between two non-reflected fibers.

In the exemplary embodiment according to FIG. 7b, the fiber pairs are located on the opposite side of the center axis A of the beam profile 4, that is to say either above or below the horizontal center axis A. The extent Wy of the beam profile extending transversely with respect to the longitudinal axes of the fibers corresponds to at least twice the sum of the diameters of all the fibers lying one next to the other and of the intermediate distances.

By means of the device according to the invention for splicing optical waveguides according to the exemplary embodiments described above, the optical waveguide fibers which are to be spliced have laser radiation with approximately equal power density applied to them from two opposite directions, heating them. As a result the splice quality, characterized in particular by coupling losses and the tensile strength of the splice, can be improved in comparison with one-sided heating. The optical system causes the laser radiation from both directions to strike the fibers at the same position along the longitudinal axes of the fibers. This is the case in particular if the point at which the laser radiation strikes the fibers is moved along the fiber axes, as illustrated schematically in particular in FIG. 1.

In particular when a plurality of fibers are welded, it is particularly advantageous to have a beam profile at the location of the fibers whose extent and power density is approximately equal in the direction of the longitudinal axes of the fibers at any transverse position with respect to the longitudinal axes of the fibers. This may be achieved, for example, by means of a diffractively acting optical element which is combined, for example, with the lens 11 according to FIG. 1. The great advantage of a diffractively acting optical arrangement is that the beam shape and thus the power distribution in the focusing area can be adapted within a wide limit to the individual conditions of the splice arrangement by the configuration of the diffractively acting optical element. The method of operation of a diffractively acting optical element is based here on the refraction of light waves at fine structures.

In all the exemplary embodiments described it may be advantageous if a small angle α is provided between the optical axis OA1 of the first optical system and the optical axis OA2 of the second optical system within the YZ plane extending transversely with respect to the longitudinal axes of the fibers, as illustrated schematically in FIG. 8 in conjunction with FIGS. 1 and 3. As a result it is possible to avoid or reduce back-reflection of laser radiation into the laser beam source.

Instead of any optical element mentioned in the exemplary embodiments (lens, mirror) it is also possible in each case to use a combination of optical elements which act in an analogous fashion and which have, in their total effect, essentially the same relevant properties as the respective individual element. This may be advantageous in particular for compensating imaging errors.

With the device according to the invention it is also possible to weld fibers with different external diameters to one another. In this context, it is possible for different external diameters to occur both between two fibers to be welded and between different pairs of fibers. The device according to the invention can also be used for splicing optical waveguides to optical components (for example chips such as, for example, what are referred to as wavelength multiplexers, couplers, etc.). When optical waveguides are spliced to optical components, one of the optical waveguides to be spliced is, as it were, an optical waveguide in the optical component.

1-17. (canceled)

18. A device for thermally treating at least one optical waveguide;
said device comprising:
a radiation source configured to thermally treat at least one optical waveguide;
a first optical system configured to direct a beam, emitted by the radiation source, onto the optical waveguide from a first side, wherein the first optical system generates a beam profile of the beam whose extent in the transverse direction with respect to a longitudinal axis of the optical waveguide corresponds to at least twice a diameter of the optical waveguide, the optical waveguide is positioned completely outside a center axis of the beam profile in the transverse direction with respect to the longitudinal axis of the optical waveguide in the focusing area of the beam inside which the radiation strikes the optical waveguide; and
a second optical system which is positioned behind the optical waveguide in the direction of a beam path of the beam and which reflects radiation which is transmitted past the side of the optical waveguide and directs it onto the optical waveguide from a second side.

19. The device as claimed in claim 18, wherein the second optical system is configured to image the emitted beam profile in a plane parallel to a longitudinal axis of the optical waveguide in a different way than in a plane extending transversely with respect to the longitudinal axis of the optical waveguide.

20. The device as claimed in claim 19, wherein the second optical system is configured to image the beam profile in a noninverted fashion in the plane parallel to the longitudinal axis of the optical waveguide and images it in an inverted fashion in the plane extending transversely with respect to the longitudinal axis of the optical waveguide, in particular in each case with an approximate ratio of 1:1.

21. The device as claimed in claim 18, wherein the second optical system comprises a plane mirror and an aspherical lens wherein the lens is arranged between the optical waveguide and the plane mirror.

22. The device as claimed in claim 21, wherein the aspherical lens has two different focal lengths in the plane parallel to the longitudinal axis of the optical waveguide and in the plane extending transversely with respect to said longitudinal axis.

23. The device as claimed in claim 21, wherein the plane extending transversely with respect to the longitudinal axis of the optical waveguide a focal length of the aspherical lens is essentially equal to the distance between the lens and the optical waveguide.

24. The device as claimed in claim 18, wherein the second optical system comprises a plane mirror and two cylindrical lenses, the lenses are arranged between the optical waveguide and the plane mirror, a first lens of the lenses does not have any refractive power in a plane parallel to a longitudinal axis of the optical waveguide, and a second lens of the lenses does not have any refractive force in a plane extending transversely with respect to said longitudinal axis.

25. The device as claimed in claim 18, wherein the second optical system comprises a plane mirror, a spherical lens and a cylindrical lens, the lenses are arranged between the optical waveguide and the plane mirror, the spherical lens has the same refractive power in a plane parallel to a longitudinal axis of the optical waveguide an, in a plane extending transversely with respect to said longitudinal axis, and the cylindrical lens does not have any refractive power in one of the planes.

26. The device as claimed in claim 24, wherein focal length of one of the lenses is essentially equal to the distance between this lens and the optical waveguides in the plane extending transversely with respect to the longitudinal axis of the optical waveguide.

27. The device as claimed in claim 18, wherein the second optical system comprises a cylindrical mirror which is concave in a plane extending transversely with respect to a longitudinal axis of the optical waveguide, and a cylindrical lens, the cylindrical lens does not have any refractive power in the plane extending transversely with respect to a longitudinal axis of the optical waveguide, and the cylindrical mirror is planar in a plane parallel to the longitudinal axis of the optical waveguide.

28. The device as claimed in claim 27, wherein the plane extending transversely with respect to the longitudinal axis of the optical waveguide a focal length of the cylindrical mirror is essentially half the distance between the cylindrical mirror and the optical waveguide.

29. The device as claimed in claim 18, wherein the device is configured in such a way that a plurality of optical waveguides which are arranged one next to the other can be treated thermally in parallel, in particular can be welded in parallel with optical waveguides lying correspondingly opposite.

30. The device as claimed in claim 29, wherein a distance between two optical waveguides lying one next to the other corresponds to at least a diameter of the optical waveguide, the extent of the beam profile extending transversely with respect to a longitudinal axis of one of the optical waveguides in the focusing area corresponds to at least the sum of the diameters of all the optical waveguides lying one next to the other and of the intermediate distances, wherein the beam profile extends over an outermost optical waveguide by a length of the order of magnitude of at least one diameter of one of the optical waveguides.

31. The device as claimed in claim 29, wherein the optical waveguides lying one next to the other are arranged on the opposite side of a center axis of the beam profile, the extent of the beam profile extending transversely with respect to a longitudinal axis of one of the optical waveguides in the focusing area corresponds to at least twice the sum of the diameters of all the optical waveguides lying one next to the other and of the intermediate distances.

32. The device as claimed in claim 18, wherein a plane extending transversely with respect to a longitudinal axis of the optical waveguide an angle is provided between an optical axis of the first optical system and an optical axis of the second optical system.

33. The device as claimed in claim 18, wherein the first optical system has a diffractively acting optical element.

34. The device as claimed in claim 18, wherein the first optical system has an optical component for directing the beam onto the optical waveguide to be spliced, the device has a drive device for the optical component, wherein the optical component can be moved with the aid of the drive device in such a way that a position of the focusing area of the beam can be shifted in its longitudinal direction, in particular can be moved periodically.
